(19) United States
(12) Patent Application Publication
(10) Pub. No.: US 2020/0375220 A1
(43) Pub. Date: Dec. 3, 2020

(54) ENERGY SUPPLEMENT

(71) Applicant: Terry Roshau, St. Augustine, FL (US)

(72) Inventor: Terry Roshau, St. Augustine, FL (US)

(21) Appl. No.: 16/424,177

(22) Filed: May 28, 2019

(51) Int. Cl. A23L 2/38; A23L 33/175; A23L 33/15

(52) U.S. Cl. CPC A23L 2/38; A23L 33/175; A23L 33/15; A23V 2002/00; A23V 2250/065; A23V 2250/626; A23V 2250/7046; A23V 2250/161; A23V 2250/0612; A23V 2250/026; A23V 2250/0634; A23V 2250/314

(57) ABSTRACT

Compositions for energy supplements are provided containing L-tryptophan in an amount of 15-28%, CoQ10 in an amount of 7-15%, pyrroloquinaline quinone in an amount of 0.4-5%, niacinamide in an amount of 2-9%, niacin in an amount of 0.4-5%, magnesium in an amount of 4-20%, acetyl-L-carnitine in an amount of 10-28%, alpha liolic acid in an amount of 10-30%, N-acetyl cysteine in an amount of 4-15%, and resveratrol an amount of 3-14% administered with a daily supplement of D-Ribose in an amount of 500 mg to 15,000 mg. The compositions providing an unexpected increase in mitochondrial biogenesis, activity, and preservation and therefore increased energy availability.

### FIELD OF THE INVENTION

The present invention pertains to an energy supplement, preferably used as a beverage, or beverage and capsule combination, with unexpected efficiencies in the therapeutic combination disclosed providing the user with increased energy without the use of common stimulants through promoting mitochondrial biogenesis, efficiency and preservation.

### BACKGROUND OF THE INVENTION

There exist a number of supplements and drinks designed to aid human performance and promote vitality or energy. The majority of the known human performance drinks are of three types: (1) those that provide electrolytes; (2) those that provide vitamins; and (3) those that provide energy through use of sugar and caffeine. All of these forms of supplements are for immediate and short-term benefit, often lasting no more than a few hours and often include detrimental side effects with long term use.

Examples of electrolyte providing drinks include drinks providing sodium, potassium, calcium, and magnesium. Brand name examples of electrolyte drinks include Gatorade® and Powerade®. In the prior art electrolyte providing energy drinks are used to replace electrolytes lost due to sweat. Examples of vitamin providing drinks include drinks providing vitamin B (B-1, B-2, B-6, B-12) and other vitamins. These types of drinks are often physiologically neutral with regular moderate use, being primarily palliative in their effectiveness.

More commonly there are energy drinks and supplements that provide caffeine and sugar, often combined with vitamins. Such brand name examples include Red Bull®, Monster®, Rockstar® and 5-Hour Energy®. These types of stimulants have short term effects and often result in a ‘crash’ or post-effect condition of reduced energy. Stimulant based energy drinks can also have detrimental consequences with consistent long-term use and can be dangerous for the elderly and persons with certain health concerns such as heart conditions or high blood pressure.

Numerous innovations in the prior art have attempted to approach this problem, each with its own failings. For example, U.S. Pat. No. 8,642,097 (Maniga) discloses a combination of pine bark, grape seed extract, coenzyme Q10 (“CoQ10”) and various herbs to effectively mimic the contents of prior energy drinks by replacing common caffeine-like chemical components with their ‘natural’ analog.

U.S. Pub. US20080193604A1 (Melton) discloses a combination of caffeine, such as coffee, combined with ginseng, sassafras, oat straw, pollen and vitamins, essentially combining nutraceutials with common herbs and vitamins to make a fusion of a vitamin based energy drink and more common caffeine based energy drinks.

U.S. Pub. US20130189417A1 (Fasullo-Nachtrieb) discloses a coffee combined with cacao and herbs commonly used as a vitamin source, such as rosehips, hibiscus and fruit, again combining a common caffeine source with nutraceutials and herbs.

Similarly, U.S. Pub US20080057161A1 (Brucker, et al.) is another disclosure of coffee with vitamin and mineral additives again combining a common caffeine source with nutraceutials.

The foregoing references disclose the common approach to energy drinks, generally by combining caffeine in either a common or uncommon form together with vitamins either in their refined or natural from as an herb or other organic type source. However, the foregoing references each fail to address the underlying metabolic processes addressed by the present disclosure or provide a relatively inexpensive means to improve mitochondrial activity in the cells of a user.

In the prior art, the energy supplements and drinks are promoted to overcome tiredness due to lack of sleep generally by increasing heart rate and raising sugar levels in the body. However none of the disclosed energy drinks work on a fundamental level to promote the actual efficiency and creation of energy in key metabolic pathways. What is needed is an energy drink that does not overwork the heart or result in a metabolic crash while providing nutrition and improving the efficacy of a body's metabolism, and having a lasting improvement not just a temporary boost, thus effecting increased energy.

### SUMMARY OF THE INVENTION

An object of the present invention is to provide a supplement or beverage that will improve the general energy levels of the user.

Another object of the present invention is to provide a supplement or beverage that will improve the general energy levels of the user without the use of common stimulants that may be harmful.

Another object of the present invention is to provide a supplement or beverage that will help reduce illness from mitochondrial decline common with age.

Another object of the present invention is to provide a supplement or beverage that will assist the body maintaining useful levels of metabolic enzymes to facilitate energy production.

Another object of the present invention is to provide a supplement or beverage that will increase available energy and vitality for stable and extended duration throughout the maintenance of the supplement therapy as opposed short terms spikes or bursts.

The fundamental engine that provides energy for activity is found in human mitochondria. Mitochondria are believed to have descended from the first bacteria billions of years ago and merged with our cells in a somewhat symbiotic relationship. They produce the energy all life needs to be “life.” The key component of mitochondrial energy production is Adenosine Triphosphate or ATP.

The present invention achieves the goal of increasing available energy with the unexpected combination of effects by combining supplements that promote the creating of new mitochondria or mitochondria biogenesis. The effectiveness of the mitochondria created is further enhanced as the disclosed therapeutic combination protects existing mitochondria from degradation by increasing its resistance to detrimental forces.

While there are therapies that claim to promote the growth of mitochondria, and some which claim to promote the effectiveness of mitochondria, none are known to accomplish both of these tasks together with providing improved protection and resistance of mitochondria to degradation. Further it appears that the augmentation of each of these stages with the disclosed therapy results not in an expected linear benefit, but in an augmented benefit with the net results of the combined therapy being greater than the anticipated sums of the components.

### DETAILED DESCRIPTION OF THE INVENTION

Mitochondrial biogenesis can be defined as the growth and division of pre-existing mitochondria and also their size and mass. A component of the aging process is for Mitochondria to decline in numbers. Promoting more and larger mitochondria provides more energy or vitality and can help counteract the natural decline in available energy that often accompanies aging. Further loss of energy in the aging process can come from an increase in hypoxia-inducible factor 1-alpha, commonly called HIF-1. Thus countering the impact of HIF-1 can also lead to more available energy.

As the cell's ATP power generators, mitochondria are the site of oxidative activity that produces destructive free radicals. DNA in the cell's nucleus is protected by numerous “guardian” proteins that blunt the impact of free radicals. It is housed within a protective double-membrane that separates it from the rest of the cell. No such repair systems exist to protect mitochondrial DNA, it is left almost entirely exposed. Thus supplementation with mitochondrial-protecting antioxidants can help preserve those mitochondria created.

The disclosed energy supplement is optionally used in a number of forms. The description herein provides for an energy drink in a solution that is ready to drink, such as from a small individual serving container. However, it is disclosed that the supplement may be distributed in one or more pills or capsule form to be taken in combination with a powder to be mixed in a liquid, or may be provided in a sachet or as a powder which maybe added to a liquid for individual servings or in other forms of concentrate allowing the user to mix with water or into a food or beverage. Packaging for the formulation includes any package or container for holding a solid, liquid, emulsion, suspension, or the like, such as a can, a bottle, a pouch, gauze bag, or a packet. Packaging may also be for bulk product, multiple servings, or a single dose. Optionally, the formulation is contained as a dry powder in a pouch, such as an easy tear open flexible mini-pouch containing one or more servings, but may be volumetrically diluted with inert and/or secondary ingredients to assist in measuring such that the per service dilution may be in a convenient easily measured volume such as a teaspoon.

It is further disclosed that the invention may be distributed in multiple components such as one or more capsules comprised of the majority of the micronutrients and a separate powder or other carrier for the volumetrically larger D-ribose component In such a forms, the active micronutrients components of one or more capsules may contain, by weight, L-tryptophan in an amount of 15%-28%, CoQ10 in an amount of 7%-15%, pyrroloquinaline quinone in an amount of 0.4%-5%, niacinamide in an amount of 2%-9%, niacin in an amount of 0.5%-4%, magnesium in an amount of 4%-20%, acetyl-L-carnitine in an amount of 10%-28%, alpha lipoic acid in an amount of 10%-30%, N-acetyl L-cysteine in an amount of 4%-15%, and resveratrol an amount of 3%-14%. In such a formulation a balance of D-ribose in an amount of approximately 100%-2,000% of the capsule ingredient weight may then be provided in a separate manner, such as a powder or in its own separate capsule form.

In absolute weight, it is disclosed that for therapeutic effect the active micronutrients components of one or more capsules to be taken daily may contain, 71 mg-132 mg L-tryptophan, 32 mg-71 mg CoQ10, 2 mg-24 mg pyrroloquinaline quinone, 9 mg-42 mg niacinamide, 2 mg-19 mg niacin, 19 mg-92 mg magnesium, 47 mg-131 mg acetyl-L-carnitine, 47 mg-141 mg alpha lipoic acid, 19 mg-71 mg N-acetyl L-cysteine, and 14 mg-66 mg resveratrol. In such a formulation a balance of D-ribose in an amount of 500 mg-15,000 mg may then be provided in a separate manner, such as a powder or in its own separate capsule form.

While a large range of useful values of the components of the supplement may be utilized, in the preferred embodiment the daily therapeutic combination comprises 25 mg of niacin, 75 mg of niacinamide, 150 mg of magnesium, 300 mg of L-tryptophan, 150 mg CoQ10, 14 mg pyrroloquinaline quinone, 250 mg acetyl L-carnitine, 225 mg alpha liolic acid, 120 mg n-acetyl cysteine, and 100 mg resveratrol, with 5,000 mg of D-ribose.

### Preferred Embodiment

D-ribose 5,000 mg

L-tryptophan 300 mg

CoQ10 150 mg

niacinamide 75 mg

niacin 25 mg

magnesium 150 mg

acetyl-L-carnitine 250 mg

alpha lipoic acid 225 mg

N-acetyl cysteine 120 mg

resveratrol 100 mg

pyrroloquinaline quinone 14 mg

Specifics of Utility

Essential components for production of ATP include co-enzyme Q-10 or CoQ10. CoQ10 helps convert the bonding energy of glucose and fat substrates. CoQ10 combines them with oxygen into the useful biological ATP energy which is a process that is managed by mitochondria. As part of the mitochondrial electron transport chain, CoQ10 accepts electrons from reduced nutrients and transfers them between cells and within the cell organelles. CoQ10 also helps form the need ATP energy source by transferring protons outside the inner mitochondrial membrane. This creates a proton charge across that membrane so the energy is released when the protons flow back into the mitochondrial interior. In operation, CoQ10 as a component of a therapy increases efficiencies of mitochondrial function and preservation, and therefore available energy.

Nicotinamide adenine dinucleotide or NAD is a coenzyme found in all living cells. NAD and in its charged state, NAD+, are part in the Krebs cycle to produce ATP and further supports mitochondrial biogenesis. It is essential for mitochondria energy production and is required for our sirtuins to function properly. NAD, or NAD+ is used to fuel the activity of sirtuins, including SIRT1. NAD and sirtuins work together as cells' nuclei send signals to mitochondria to maintain their normal operation. SIRT1 helps insure the signals get through. When NAD levels drop, SIRT1 activity falls off crucial signals fade leading to mitochondrial dysfunction, yet when both are maintained at saturation levels, their augmented effect is increased and helps induce formation of new mitochondria and SIRT3 which keeps mitochondria running smoothly. Niacin and niacinamide promote the formation and maintenance of NAD.

Sirtuins also help induce formation of new mitochondria and keep mitochondria running smoothly. Sirtuin proteins limit the detrimental impact of HIF-1 in metabolic pathways, but with aging and their decline HIF-1 metabolic inhibition increases. Studies have shown that improved NAD levels can increase the effectiveness of sirtuin proteins and thus counter HIF-1. NAD and also sirtuin proteins play a key role in communicating between the cell nucleus and the mitochondria that power all activity in our cells.

To offset losses due to aging and promote NAD formation there are nutrients which may be used as a direct NAD precursor, such as nicotinamide mononucleotide (often referred to as NMN) and nicotinamide riboside (a form of vitamin B3, often referred to as NR). They have been shown to increase NAD levels and thereby suppress HIF-1 and facilitate general energy production. However, they can have negative consequences if misused by the average consumer. To overcome such issues, included with the disclosed therapy is a blend of safe nutrients to promote the formation of NAD. This allows the body to better regulate the amount of NAD to produced and facilitate such production. This combination of nutrients includes niacin, L-tryptophan, niacinamide, and resveratrol or pterostilbene. With the disclosed therapy NAD levels may be boosted to promote available energy and offset energy losses due to aging mitochondria, and without the negative consequences of nicotinamide mononucleotide (NMN) and nicotinamide riboside (NR).

D-ribose is a 5-carbon sugar chain (as opposed to the normal 6-carbon sugar chains) and critical in promoting energy levels and maintaining tryptophan levels and anabolic energy pathways in mitochondria ATP production. D-Ribose is used in the generation of NADPH (nicotinamide adenine dinucleotide phosphate) a critical enzyme in energy production and forms the structural foundation of the ATP molecule.

Pyrroloquinoline quinone (PQQ) is a nutrient that provides extraordinary defense against mitochondrial decay and its chemical structure enables it to withstand oxidation up to 5,000 times greater than vitamin C. PQQ is the singular most important molecule, when combined with CoQ10, in the production of new mitochondria. This compound helps activate the genes that stimulate mitochondrial biogenesis. Research shows PQQ, in doing this, can significantly preserve and enhance memory, attention, and cognition in aging humans in addition to the promotion and preservation of mitochondrial energy.

R-Alpha lipoic acid, or R-ALA is important in several processes. It is an excellent catalyst that can “recycle” vitamins C and E to their active states as well as being a potent antioxidant in aqueous and fatty tissue environments. Without sufficient R-ALA the mitochondria would be unable to breakdown alpha-keto acids and free amino acids that are needed to produce acetyl-coenzyeme A (CoA). Facilitating R-ALA production with the disclosed therapy provides widespread protection to the mitochondria membrane, both intracellularly and extracellularly. It also provides important intermediates that supply the citric acid cycle, as well as protect the electron transport chain from free radical damage so maximum energy production can take place.

Acetyl-L-carnitine or ALC works together with CoQ10 in mitochondrial activity. ALC is an obligatory cofactor for beta-oxidation of fatty acids by facilitating the transport of long-chain fatty acids across the mitochondrial membrane as acylcarnitine esters. It unites with these fatty acids and helps carry them into the mitochondria so they can be used for energy and to the individual cells.

The combination of R-ALA and ALC as provided for in the disclosed therapy significantly promotes the production and preservation of viable mitochondria, expression of mitochondrial DNA, mitochondrial complexes, and the expression of several transcription factors involved in mitochondrial biogenesis. In contrast, the treatments with only R-ALA or ALC alone at the same concentrations have shown little effect on mitochondrial function and biogenesis.

ALC has also been shown to up-regulate complex bc1 gene expression increasing the mitochondrial antioxidant defenses and facilitating either the repair of less damaged mitochondria or the degradation of the most damaged ones by enhancing the mitochondrial DNA transcription and stability of mRNA and protecting membrane integrity against lipid peroxidation and membrane breakdown.

Magnesium is the fourth most abundant cation in the body and plays an important role in cellular metabolism. Magnesium balance is maintained by renal regulation of magnesium reabsorption. Magnesium deficiency is a common problem that can be more pronounced as people age and kidney function diminishes. Magnesium deficiency can cause a wide variety of features including hypocalcaemia, hypokalaemia and cardiac and neurological manifestations. Chronic low magnesium state has been associated with a number of chronic conditions and diseases including fatigue, diabetes, hypertension, coronary heart disease, and osteoporosis.

In metabolic pathways magnesium protects mitochondria from destructive oxidization reactions and facilitates the transfer of ATP energy and phosphate bonds in ATP production. Maintaining proper magnesium levels also assists in controlling the integrity and permeability of the mitochondrial membrane.

N-acetyl cysteine or NAC increases glutathione and attenuates muscular fatigue via multiple cellular mechanisms. Cysteine is the rate-limiting amino involved in glutathione formation. When sufficient amounts of cystine are available, glutathione's antioxidant capacity is improved and NAC production is facilitated. More importantly, NAC delivers fatty acids to the mitochondria to be consumed for fuel. A portion of electrolyte depletion is due to the decreased activity of the Na+/K+ pumps. NAC also helps preserve plasma K+ concentrations and improve K+ regulation, delaying fatigue.

Resveratrol is a popular dietary supplement because of its ability to activate sirtuin proteins and NAD in our cells. However, sirtuins that are activated by resveratrol require NAD+ as their energy substrate and failure to supplement both resveratrol and NAD leads to a loss of NAD+ and impedes beneficial sirtuin function. As a result, combining resveratrol with more niacin and niacinamide supports healthy cellular NAD+ levels, which are important to support anti-aging enzymes and mitochondrial effectiveness and long-term viability. It is also disclosed that pterostilbene is a functional equivalent to resveratrol and may be substituted for resveratrol upon availability.

While many of the elements of the disclosed therapy have been known in the art to provide a narrow-targeted benefit, the unique combination disclosed herein has hereto before not been known. Further the combination disclosed appears to have a synergistic and unexpected result of notably improved benefits that would not be expected from a linear combination of the component elements.

With respect to the above description it is to be realized that the optimum perpotional relationship for the components of the invention include variations in volume and proportion which are readily apparent and obvious to one skilled in the art, and all bio-equivalents and equivalent relationships to those described in the specification are intended to be encompassed by the present invention.

Therefore, the foregoing is considered as illustrative only of the principles of the invention. Further, since numerous applications, modifications and changes will readily occur to those skilled in the art, it is not desired to limit the invention to the exact construction and formulation described, and accordingly, all suitable modifications and equivalents may considered falling within the scope of the invention as formally claimed below.

What is claimed is:

1. A supplement comprising by percentage weight of active ingredients:
L-tryptophan in an amount of 15-28%,
CoQ10 in an amount of 7-15%,
pyrroloquinaline quinone in an amount of 0.4-5%, and
a daily amount of 500 mg to 15,000 mg of D-ribose.

2. The supplement of claim 1, further comprising by weight:
niacinamide in an amount of 2-9%.

3. The supplement of claim 1, further comprising by weight:
niacin in an amount of 0.5-4%.

4. The supplement of claim 1, further comprising by weight:
magnesium in an amount of 4-20%.

5. The supplement of claim 1, further comprising by weight:
acetyl-L-carnitine in an amount of 10-28%.

6. The supplement of claim 1, further comprising by weight:
alpha liolic acid in an amount of 10-30%.

7. The supplement of claim 1, further comprising by weight:
N-acetyl cysteine in an amount of 4-15%.

8. The supplement of claim 1, further comprising:
resveratrol an amount of 3-14%.

9. A supplement comprising by percentage weight of active ingredients:
L-tryptophan in an amount of 15-28%,
CoQ10 in an amount of 7-15%,
pyrroloquinaline quinone in an amount of 0.4-5%,
niacinamide in an amount of 2-9%,
niacin in an amount of 0.4-5%,
magnesium in an amount of 4-20%,
acetyl-L-carnitine in an amount of 10-28%,
alpha liolic acid in an amount of 10-30%,
N-acetyl cysteine in an amount of 4-15%, and
resveratrol an amount of 3-14%.

10. The supplement of claim 9, further comprising:
D-ribose in amount of 100%-2,000%.

11. A preferred daily supplement comprising by weight of active ingredients:
L-tryptophan in an amount of 100 mg-600 mg,
CoQ10 in an amount of 50 mg-400 mg,
pyrroloquinaline quinone in an amount of 6 mg-30 mg,
niacinamide in an amount of 25 mg-200 mg,
niacin in an amount of 10 mg-100 mg,
magnesium in an amount of 40 mg-400 mg,
acetyl-L-carnitine in an amount of 100 mg-500 mg,
alpha liolic acid in an amount of 75-400 mg,
N-acetyl cysteine in an amount of 50 mg-300 mg, and
resveratrol an amount of 40 mg-300 mg.

12. The supplement of claim 11, further comprising:
D-ribose in amount of 500 mg-15,000 mg.
